(19) United States
(12) Patent Application Publication
(10) Pub. No.: US 2011/0253464 A1
(43) Pub. Date: Oct. 20, 2011

(54) SUSPENSION SYSTEM FOR ELECTRIC WHEELCHAIR

(75) Inventor: MAO-CHIANG CHEN, KAOHSIUNG COUNTY (TW)

(73) Assignee: FREERIDER CORP., KAOHSIUNG COUNTY (TW)

(21) Appl. No.: 12/760,795

(22) Filed: Apr. 15, 2010

(51) Int. Cl. A61G 5/10

(52) U.S. Cl. 180/65.1

(57) ABSTRACT

A suspension system for an electric wheelchair is revealed. A pivot on a front end of a wheelchair frame pivotally connects a front wheel frame and a drive set frame. A front suspension system is disposed between the front wheel frame and a drive set frame. The front wheel frame is assembled with front wheels, the drive set frame is disposed with a drive set and a drive wheel is arranged at a power output end of the drive set. Moreover, an auxiliary suspension device is arranged between the drive set frame and the frame while a rear end of the frame is disposed with rear wheels. Thereby the electric wheelchair has good stability and slip-resistance, not easily overturned or slid by interaction between the front and the auxiliary suspension devices while driving through concave surfaces or convex surfaces. Therefore the safety of users seated in wheelchairs is assured.

### BACKGROUND OF THE INVENTION

1. Fields of the Invention

The present invention relates to a suspension system for an electric wheelchair, especially to an electric wheelchair that is with good stability, not easily overturned while moving over an uneven road such as a concave surface or a convex surface. Thus the safety of the user seated in the wheelchair is assured.

2. Descriptions of Related Art

Some people are paralyzed below their lower half due to serious injuries in car accidents or a stroke caused by a serious illness. Some are patients confined by illness and unable to walk. These conditions result in muscular atrophy and weakness in their legs. Thus they are unable to walk smoothly. Some are older people that move slowly because of their physical conditions that impair mobility or balance. Once these handicapped people intend to move or walk, they badly need mobility aids such as wheelchairs or crutches that help them move around. However, these mobility aid devices are operated manually. The operation of the device is not only energy consuming but the moving speed is also limited. This causes trouble and inconvenience to users.

Thus some manufactures have invented various transport vehicles such as electric scooters, electric wheelchairs, etc. By the power from electricity, handicapped people can move more easily and conveniently.

Although electric wheelchairs give handicapped people mobility, the electric wheelchairs still have some problems in use. The electric wheelchair generally includes front and rear wheels, both disposed with at least one suspension device. Moreover, rear wheels are used as main drive wheels for power transmission. During movement, the electric wheelchair is easy to slide or overturn while crossing over concave or convex terrain and this jeopardizes lives of users. Thus the stability of the electric wheelchair still needs to be improved.

### SUMMARY OF THE INVENTION

Therefore it is a primary object o the present invention to provide a suspension system for an electric wheelchair so that the electric wheelchair will not overturn or slide easily no matter passing a convex surface or a concave surface on roads.

In order to achieve above objects, a suspension system for an electric wheelchair according to the present invention includes a pivot pivotally that connects a front wheel frame and a drive set frame on a front end of a frame of the electric wheelchair. Front suspension devices are positioned between the front wheel frame and the drive set frame. The front wheel frame is assembled with front wheels, the drive set frame is disposed with a drive set and a drive wheel is arranged at a power output end of the drive set. Moreover, auxiliary suspension devices are arranged between the drive set frame and the frame while a rear end of the frame is disposed with rear wheels. Thereby, according to the front suspension device arranged between the front wheel frame and the drive set frame, and the auxiliary suspension device positioned between the drive set frame and the frame, the auxiliary suspension device absorbs the force the front suspension device acted on the drive set frame. Thus the electric wheelchair is stable and is not easily overturned or slid no matter passing through an uneven road such as a concave surface or a convex surface. Therefore, the safety of the user seated in the wheelchair is assured.

The suspension system for an electric wheelchair of the present invention further includes rear suspension devices are positioned on a rear end of the frame. A rear wheel frame is pivotally connected with each of two sides of the rear end of the frame by another pivot. Rear wheels are arranged at the rear wheel frame. The rear suspension devices are positioned between the rear wheel frame and the frame. Thereby the rear suspension devices absorb shock of the rear wheels while driving through a bumpy road so as to keep stability of the electric wheelchair.

### BRIEF DESCRIPTION OF THE DRAWINGS

FIG. 1 is a perspective view of a frame of an electric wheelchair according to the present invention;

FIG. 2 is a schematic drawing showing one side of a frame of an electric wheelchair according to the present invention;

FIG. 3 is a schematic drawing showing an electric wheelchair crossing over a concave surface on roads;

FIG. 4 is a schematic drawing showing an electric wheelchair crossing over a convex surface on roads.

### DETAILED DESCRIPTION OF THE PREFERRED EMBODIMENT

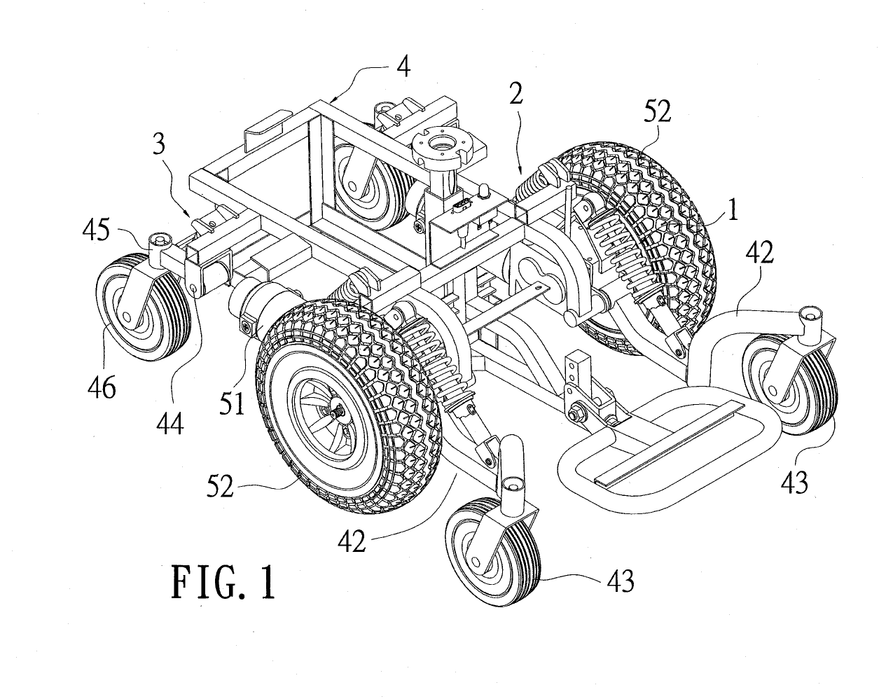

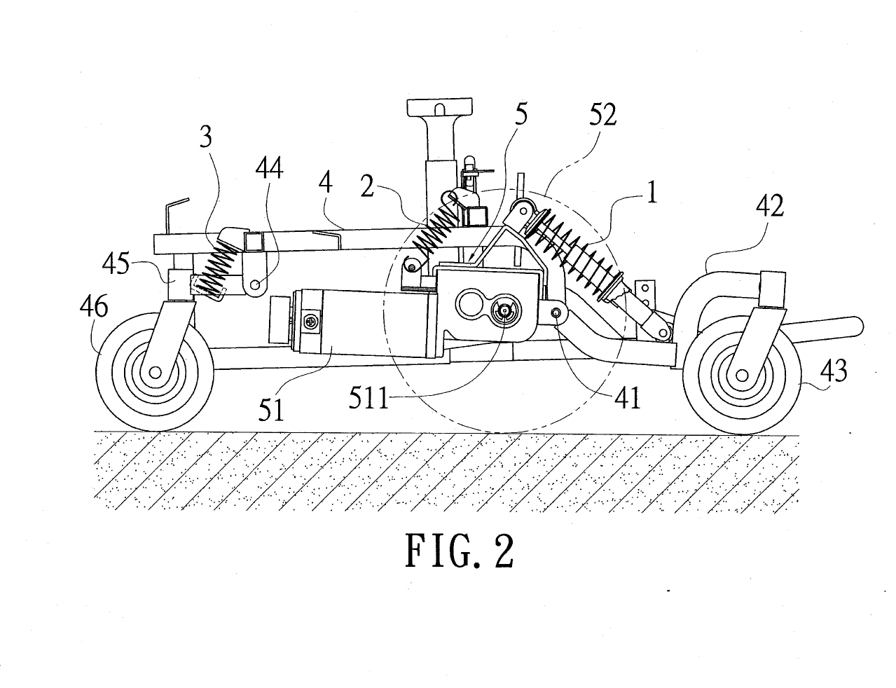

Refer to FIG. 1 and FIG. 2, a suspension system in electric wheelchairs according to the present invention includes front suspension devices 1 and auxiliary suspension devices 2.

The front suspension device 1 and the auxiliary suspension device 2 are arranged at a front end of a frame 4 of an electric wheelchair. A first pivot 41 is disposed on each of two sides of the front end of the frame 4. A front wheel frame 42 and a drive set frame 5 are pivotally connected with each other by the first pivot 41. The front wheel frame 42 is assembled with front wheels 43 while the drive set frame 5 is disposed with a drive set 51 and a drive wheel 52 is arranged at a power output end 511 of the drive set 51. Moreover, two ends of the front suspension device 1 are respectively connected with the front wheel frame 42 and the drive set frame 5 while the auxiliary suspension device 2 is disposed between the drive set frame 5 and the frame 4 of the electric wheelchair. The auxiliary suspension device 2 can be an extension spring.

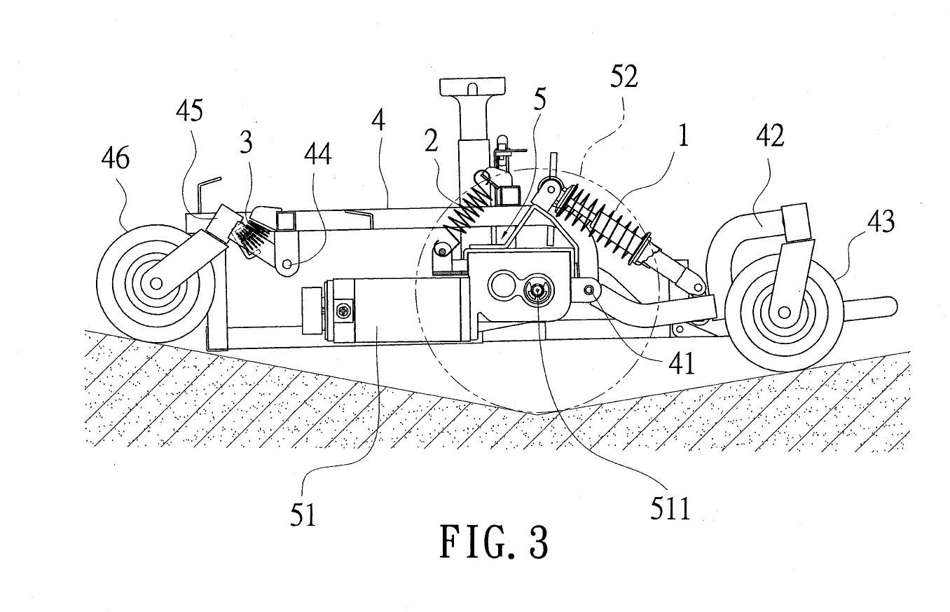

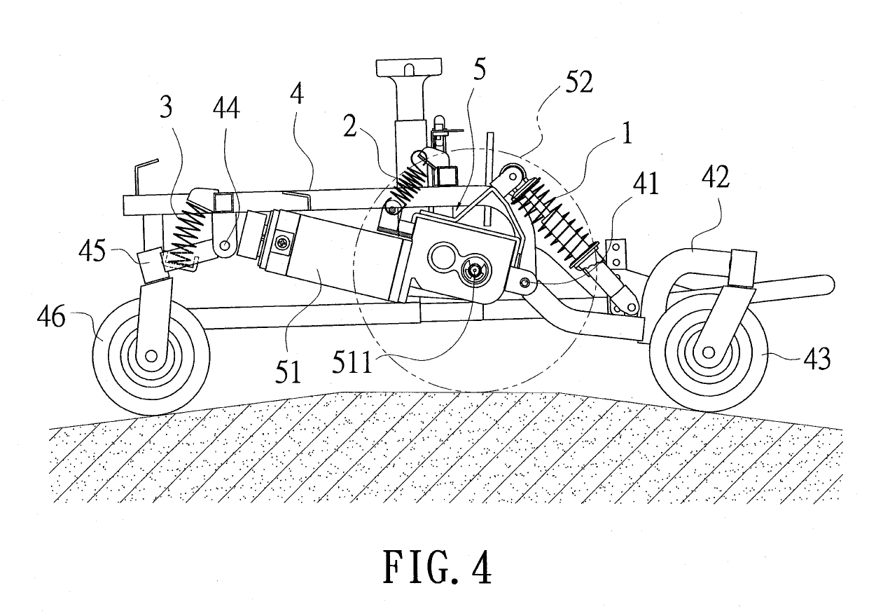

Also refer to FIG. 3 and FIG. 4, thereby by the front suspension device 1 between the front wheel frame 42 and the drive set frame 5, and the auxiliary suspension device 2 between the drive set frame 5 and the frame 4, the front wheel 43 rises to compress the front suspension device 1 when the front wheel 43 moves over a convex surface that is higher than the surface the drive wheel 52 positioned. Moreover, the force that the front wheel 43 acted on the front suspension device 1 is transmitted to the drive set frame 5 so that the drive set frame 5 is pressed downward and is pivoted toward the direction of the force around the first pivot 41. Thereby the auxiliary suspension device 2 is pulled and extended by the drive set frame 5 so as to absorb the force that the front suspension device 1 acted on the drive set frame 5. On the other hand, the drive wheel 52 moves upward to compress both the front suspension device 1 and the auxiliary suspension device 2 so as to absorb shock of the drive wheel 52 when the front wheel 43 passes over a concave surface that is lower than the surface the drive wheel 52 positioned.

The suspension system in electric wheelchairs of the present invention further includes rear suspension devices 3 that are disposed on a rear end of the frame 4. A rear wheel frame 45 is pivotally connected with each of two sides of the rear end of the frame 4 by a second pivot 44. Rear wheels 46 are arranged at the rear wheel frame 45. The rear suspension devices 3 are positioned between the rear wheel frame 45 and the frame 4.

Thereby refer to FIG. 3 and FIG. 4 again, by the rear suspension device 3 disposed between the frame 4 and the rear wheel frame 45 connected with each of two sides of the frame 4, the shock of the rear wheel 46 is absorbed and the vibration of the rear wheel 46 is reduced when the rear wheel 46 moves over a bumpy road. Thus the electric wheelchair provides a smooth and stable ride.

In summary, the suspension system for an electric wheelchair of the present invention provides rear wheels shock absorption effects by the rear suspension device disposed between the frame and the rear wheel frame, the front suspension device arranged between the front wheel frame and the drive set frame, and the auxiliary suspension device set between the drive set frame and the frame. Moreover, the auxiliary suspension device absorbs the force the front suspension device acted on the drive set frame. Therefore, the electric wheelchair has good stability and slip-resistance, not easily overturned no matter moving through an uneven road such as a concave surface or a convex surface. Thus the safety of the user seated in the wheelchair is assured.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A suspension system for an electric wheelchair comprising:
a pivot for pivotally connecting a front wheel frame with a drive set frame on a front end of a frame of the electric wheelchair, at least one front suspension device and at least one auxiliary suspension device;
wherein the front suspension device is positioned between the front wheel frame and the drive set frame; the front wheel frame is disposed with front wheels while the drive set frame is mounted with a drive set and a drive wheel is connected with a power output end of the drive set; the auxiliary suspension device is arranged between the drive set frame and the frame and a rear end of the frame is disposed with rear wheels.

2. The device as claimed in claim 1, wherein the auxiliary suspension device is an extension spring.

3. The device as claimed in claim 2, wherein a rear end of the frame is pivotally connected with a rear wheel frame by another pivot and the rear wheel frame is disposed with rear wheels.

4. The device as claimed in claim 3, wherein at least one rear suspension device is arranged between the frame and the rear wheel frame.

5. The device as claimed in claim 1, wherein a rear end of the frame is pivotally connected with a rear wheel frame by another pivot and the rear wheel frame is disposed with rear wheels.

6. The device as claimed in claim 5, wherein at least one rear suspension device is arranged between the frame and the rear wheel frame.
